(19) United States
(12) Patent Application Publication
(10) Pub. No.: US 2025/0315813 A1
(43) Pub. Date: Oct. 9, 2025

(54) System, Method, and Computer Program Product for On-Vehicle Electronic Fee Collection

(71) Applicant: Visa International Service Association, San Francisco, CA (US)

(72) Inventors: Yuexi Chen, Foster City, CA (US); Sonia Gupta, Pleasanton, CA (US); Marc B. Kekicheff, Foster City, CA (US); Ratna Deepthi Jarugu, Sunnyvale, CA (US)

(21) Appl. No.: 19/170,102

(22) Filed: Apr. 4, 2025

Related U.S. Application Data
(60) Provisional application No. 63/575,006, filed on Apr. 5, 2024.

(51) Int. Cl. G06Q 20/32; G06Q 20/38; G06Q 20/40

(52) U.S. Cl. CPC G06Q 20/327; G06Q 20/3829; G06Q 20/405

(57) ABSTRACT

Systems, methods, and computer program products are provided for on-vehicle electronic fee collection. An example system includes at least one processor configured to receive event data from a vehicle operated by a user, the event data including a digital signature based on sensor data generated by at least one sensor of the vehicle. The at least one processor may be configured to determine a merchant system from a plurality of merchant systems based on the payment event and determine a payment event based on the event data. The at least one processor may be configured to generate transaction data based on the payment event and the merchant system and transmit a payment request message including the transaction data to the vehicle. The at least one processor may be configured to process a payment transaction based on the transaction data in response to receiving a payment confirmation message from the vehicle.

The present application claims the benefit of U.S. Provisional Patent Application No. 63/575,006, filed on Apr. 5, 2024, the disclosure of which is hereby incorporated by reference in its entirety.

### BACKGROUND

### 1. Technical Field

This disclosure relates generally to electronic fee collection and, in some non-limiting embodiments or aspects, to systems, methods, and computer program products for on-vehicle electronic fee collection.

### 2. Technical Considerations

Electronic toll collection (ETC) systems enable a user of a vehicle to automatically pay a fee (e.g., a toll at a toll booth) by driving beneath a gantry equipped with ETC devices (e.g., sensors), without stopping the vehicle. ETC systems may require hardware and software (e.g., a transponder, a radio frequency identification system, and/or a camera for automated vehicle identification and classification).

Typically, equipment on the gantry may detect and/or identify the vehicle based on a signal received from a transponder device located inside the vehicle and/or a license plate of the vehicle. The equipment on the gantry may electronically process a payment (e.g., for the toll) for users who have set up a prepaid account associated with a transponder device and/or a vehicle's license plate. Otherwise, an invoice may be generated and mailed to the registered owner of the vehicle.

Existing ETC systems are typically not interoperable between different merchants. For example, a user may not be able to pay a toll on a toll road operated by merchant A and a fee for parking in a parking garage operated by merchant B using the same ETC system. Additionally, existing ETC systems, such as camera based ETC systems and radio frequency based ETC systems, may cause privacy concerns and/or require additional equipment (e.g., gates) that are costly to install and create congestion. Further, existing ETC systems do not have effective mechanisms for identifying high occupancy vehicles (HOVs) for HOV lanes.

Electronic parking fee collection systems require parking meters, pay and display machines, or pay-by-plate machines, which are costly to set up and maintain.

### SUMMARY

Accordingly, provided are improved systems, methods, and computer program products for on-vehicle electronic fee collection.

According to non-limiting embodiments or aspects, provided is a system for on-vehicle electronic fee collection. In some non-limiting embodiments or aspects, the system may include at least one processor. In some non-limiting embodiments or aspects, the at least one processor may be configured to receive event data from a vehicle operated by a user. The event data may include a digital signature based on sensor data. The sensor data may be generated by at least one sensor of the vehicle. In some non-limiting embodiments or aspects, the at least one processor may be further configured to determine a merchant system from a plurality of merchant systems based on the event data. In some non-limiting embodiments or aspects, the at least one processor may be further configured to determine a payment event based on the event data and the merchant system. In some non-limiting embodiments or aspects, the at least one processor may be further configured to generate transaction data based on the payment event. In some non-limiting embodiments or aspects, the at least one processor may be further configured to transmit a payment request message including the transaction data to the vehicle. In some non-limiting embodiments or aspects, the at least one processor may be further configured to process a payment transaction based on the transaction data in response to receiving a payment confirmation message from the vehicle.

In some non-limiting embodiments or aspects, the at least one processor may be further configured to receive payment data corresponding to a payment device of the user and store the payment data in a database.

In some non-limiting embodiments or aspects, the event data may include a location of the vehicle. In some non-limiting embodiments or aspects, determining the merchant system from the plurality of merchant systems may be based on the location of the vehicle.

In some non-limiting embodiments or aspects, the at least one processor may be further configured to determine a merchant rule of a plurality of merchant rules based on the event data and the merchant system.

In some non-limiting embodiments or aspects, when determining the merchant rule of the plurality of merchant rules, the at least one processor may be configured to query a database including the plurality of merchant rules.

In some non-limiting embodiments or aspects, the digital signature may be based on a cryptographic key corresponding to the vehicle.

In some non-limiting embodiments or aspects, the at least one processor may be further configured to generate a payment request message including the transaction data.

According to non-limiting embodiments or aspects, provided is a computer-implemented method for on-vehicle electronic fee collection. In some non-limiting embodiments or aspects, the computer-implemented method may include receiving event data from a vehicle operated by a user. The event data may include a digital signature based on sensor data. The sensor data may be generated by at least one sensor of the vehicle. A merchant system from a plurality of merchant systems may be determined based on the event data. A payment event may be determined based on the event data and the merchant system. Transaction data may be generated based on the payment event. A payment request message including the transaction data may be transmitted to the vehicle. A payment transaction may be processed based on the transaction data in response to receiving a payment confirmation message from the vehicle.

In some non-limiting embodiments or aspects, the method may further include receiving payment data corresponding to a payment device of the user and storing the payment data in a database.

In some none-limiting embodiments or aspects, the event data may include a location of the vehicle. In some non-limiting embodiments or aspects, determining the merchant system from the plurality of merchant systems may be based on the location of the vehicle.

In some non-limiting embodiments or aspects, the method may further include determining a merchant rule of a plurality of merchant rules based on the event data and the merchant system.

In some non-limiting embodiments or aspects, determining the merchant rule of the plurality of merchant rules may include querying a database including the plurality of merchant rules.

In some non-limiting embodiments or aspects, the digital signature may be based on a cryptographic key corresponding to the vehicle.

In some non-limiting embodiments or aspects, the method may further include generating a payment request message including the transaction data.

According to non-limiting embodiments or aspects, provided is a computer program product for on-vehicle electronic fee collection. In some non-limiting embodiments or aspects, the computer program product may include at least one non-transitory computer-readable medium including program instructions that, when executed by at least one processor, may cause the at least one processor to receive event data from a vehicle operated by a user. The event data may include a digital signature based on sensor data. The sensor data may be generated by at least one sensor of the vehicle. In some non-limiting embodiments or aspects, the instructions may further cause the at least one processor to determine a merchant system from a plurality of merchant systems based on the event data. In some non-limiting embodiments or aspects, the instructions may further cause the at least one processor to determine a payment event based on the event data and the merchant system. In some non-limiting embodiments or aspects, the instructions may further cause the at least one processor to generate transaction data based on the payment event. In some non-limiting embodiments or aspects, the instructions may further cause the at least one processor to transmit a payment request message including the transaction data to the vehicle. In some non-limiting embodiments or aspects, the instructions may further cause the at least one processor to process a payment transaction based on the transaction data in response to receiving a payment confirmation message from the vehicle.

In some non-limiting embodiments or aspects, the instructions may further cause the at least one processor to receive payment data corresponding to a payment device of the user and store the payment data in a database.

In some non-limiting embodiments or aspects, the event data may include a location of the vehicle. In some non-limiting embodiments or aspects, determining the merchant system from the plurality of merchant systems may be based on the location of the vehicle.

In some non-limiting embodiments or aspects, the instructions may further cause the at least one processor to determine a merchant rule of a plurality of merchant rules based on the event data and the merchant system.

In some non-limiting embodiments or aspects, when determining the merchant rule of the plurality of merchant rules, the instructions may cause the at least one processor to query a database including the plurality of merchant rules.

In some non-limiting embodiments or aspects, the digital signature may be based on a cryptographic key corresponding to the vehicle.

In some non-limiting embodiments or aspects, the instructions may further cause the at least one processor to generate a payment request message including the transaction data.

Further non-limiting embodiments or aspects are set forth in the following numbered clauses:

Clause 1: A system, comprising: at least one processor configured to: receive event data from a vehicle operated by a user, the event data comprising a digital signature based on sensor data generated by at least one sensor of the vehicle; determine a merchant system from a plurality of merchant systems based on the event data; determine a payment event based on the event data and the merchant system; generate transaction data based on the payment event; transmit a payment request message comprising the transaction data to the vehicle; and process a payment transaction based on the transaction data in response to receiving a payment confirmation message from the vehicle.

Clause 2: The system of clause 1, wherein the at least one processor is further configured to: receive payment data corresponding to a payment device of the user; and store the payment data in a database.

Clause 3: The system of clause 1 or 2, wherein the event data comprises a location of the vehicle and wherein determining the merchant system from the plurality of merchant systems is based on the location of the vehicle.

Clause 4: The system of any of clauses 1-3, wherein the at least one processor is further configured to: determine a merchant rule of a plurality of merchant rules based on the event data and the merchant system.

Clause 5: The system of any of clauses 1-4, wherein, when determining the merchant rule of the plurality of merchant rules, the at least one processor is configured to: query a database including the plurality of merchant rules.

Clause 6: The system of any of clauses 1-5, wherein the digital signature is based on a cryptographic key corresponding to the vehicle.

Clause 7: The system of any of clauses 1-6, wherein the at least one processor is further configured to: generate a payment request message including the transaction data.

Clause 8: A computer-implemented method, comprising: receiving, with at least one processor of a server computer, event data from a vehicle operated by a user, the event data comprising a digital signature based on sensor data generated by at least one sensor of the vehicle; determining, with at least one processor of the server computer, a merchant system from a plurality of merchant systems based on the event data; determining, with at least one processor of the server computer, a payment event based on the event data and the merchant system; generating, with at least one processor of the server computer, transaction data based on the payment event; transmitting, with at least one processor of the server computer, a payment request message comprising the transaction data to the vehicle; and processing, with at least one processor of the server computer, a payment transaction based on the transaction data in response to receiving a payment confirmation message from the vehicle.

Clause 9: The computer-implemented method of clause 8, further comprising: receiving payment data corresponding to a payment device of the user; and storing the payment data in a database.

Clause 10: The computer-implemented of clause 8 or 9, wherein the event data comprises a location of the vehicle, and wherein determining the merchant system from the plurality of merchant systems is based on the location of the vehicle.

Clause 11: The computer-implemented of any of clauses 8-10, further comprising: determining a merchant rule of a plurality of merchant rules based on the event data and the merchant system.

Clause 12: The computer-implemented method of any of clauses 8-11, wherein determining the merchant rule of the plurality of merchant rules comprises: querying a database including the plurality of merchant rules.

Clause 13: The computer-implemented method of any of clauses 8-12, wherein the digital signature is based on a cryptographic key corresponding to the vehicle.

Clause 14: The computer-implemented method of any of clauses 8-13, further comprising: generating a payment request message including the transaction data.

Clause 15: A computer program product comprising at least one non-transitory computer-readable medium including program instructions that, when executed by at least one processor, cause the at least one processor to: receive event data from a vehicle operated by a user, the event data comprising a digital signature based on sensor data generated by at least one sensor of the vehicle; determine a merchant system from a plurality of merchant systems based on the event data; determine a payment event based on the event data and the merchant system; generate transaction data based on the payment event; transmit a payment request message comprising the transaction data to the vehicle; and process a payment transaction based on the transaction data in response to receiving a payment confirmation message from the vehicle.

Clause 16: The computer program product of clause 15, wherein the instructions further cause the at least one processor to: receive payment data corresponding to a payment device of the user; and store the payment data in a database.

Clause 17: The computer program product of clause 15 or 16, wherein the event data comprises a location of the vehicle and wherein determining the merchant system from the plurality of merchant systems is based on the location of the vehicle.

Clause 18: The computer program product of any of clauses 15-17, wherein the instructions further cause the at least one processor to: determine a merchant rule of a plurality of merchant rules based on the event data and the merchant system.

Clause 19: The computer program product of any of clauses 15-18, wherein, when determining the merchant rule of the plurality of merchant rules, the instructions cause the at least one processor to: query a database including the plurality of merchant rules.

Clause 20: The computer program product of any of clauses 15-19, wherein the digital signature is based on a cryptographic key corresponding to the vehicle.

Clause 21: The computer program product of any of clauses 15-20, wherein the instructions further cause the at least one processor to: generate a payment request message including the transaction data.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for on-vehicle electronic fee collection, according to some non-limiting embodiments or aspects;

FIG. 2 is a flow diagram of a method for on-vehicle electronic fee collection, according to some non-limiting embodiments or aspects;

FIG. 3 is a diagram of an example payment processing network in which systems, methods, and/or computer program products, described herein, may be implemented, according to some non-limiting embodiments or aspects;

FIG. 4 is a schematic diagram of example components of one or more devices of FIG. 1 and/or FIG. 3, according to some non-limiting embodiments or aspects;

FIG. 5 is a diagram of an example system for on-vehicle electronic fee collection, according to some non-limiting embodiments or aspects; and

FIGS. 6A and 6B are diagrams of implementations of a method for on-vehicle electronic fee collection, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “POS device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “POS system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Provided herein are systems, methods, and computer program products for on-vehicle electronic fee collection. Through the use of non-limiting embodiments described herein, a fee collection system may receive event data detected by a vehicle system using an existing on-vehicle detection system (e.g., one or more sensors) and determine a payment event associated with the vehicle. In this way, the system leverages existing on-vehicle systems without requiring additional hardware to be installed in the vehicle and/or at the merchant POS location (e.g., a parking garage, a toll booth, etc.). The fee collection system may, in some non-limiting embodiments or aspects, be a centralized system used to process payment transactions for a plurality of different merchant systems associated with a plurality of merchants (parking garages, toll booths, etc.) based on the event data received from the vehicle system (e.g., integrated in the vehicle). The vehicle system may sign the event data (e.g., with a cryptographic key) and/or encrypt the event data to anonymize the event data before sending the event data to the fee collection system. In this way, the system improves user privacy and reduces the risk of leaking private user information. The signed event data received by the fee collection system may include vehicle data (e.g., global positioning system (GPS) coordinates of a vehicle, a location of the vehicle, an occupancy of the vehicle, a position of the vehicle, and/or the like). Based on receiving the event data and/or vehicle data, the fee collection system may automatically identify a merchant system and determine whether fee collection is required. If fee collection is required and/or approved, the fee collection system may complete a transaction between a user of the vehicle and a merchant associated with the identified merchant system.

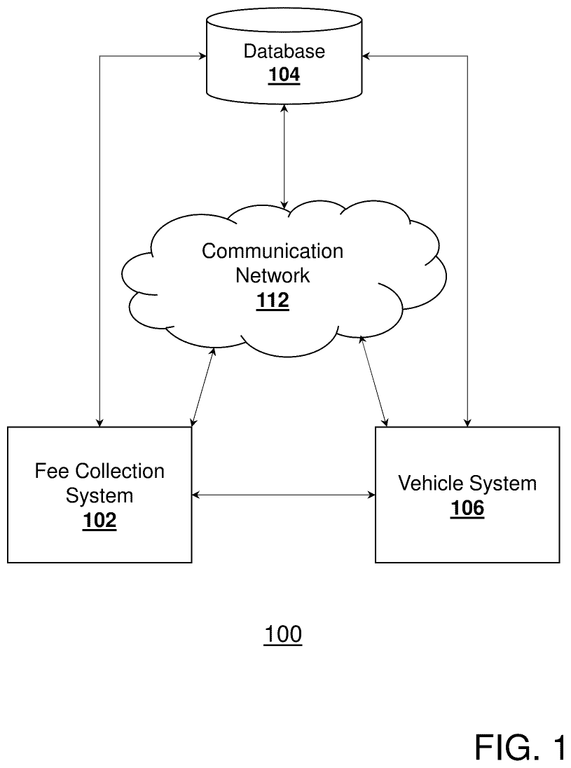

Referring now to FIG. 1, shown is a schematic diagram of system 100 for on-vehicle electronic fee collection, according to some non-limiting embodiments or aspects. As shown in FIG. 1, system 100 may include fee collection system 102, database 104, vehicle system 106, and/or communication network 112.

Fee collection system 102 may include one or more devices capable of receiving information from and/or communicating information to database 104 and/or vehicle system 106 (e.g., directly via a wired or wireless communication connection, indirectly via communication network 112, and/or the like). For example, fee collection system 102 may include a computing device. In some non-limiting embodiments or aspects, fee collection system 102 may be in communication with a data storage device (e.g., database 104), which may be local or remote (e.g., located off premises) to fee collection system 102. In some non-limiting embodiments or aspects, fee collection system 102 may be capable of receiving information from, storing information in, communicating information to, or searching information stored in the data storage device (e.g., database 104).

Database 104 may include one or more devices capable of storing data from and/or providing data to fee collection system 102 and/or vehicle system 106 (e.g., directly via a wired or wireless communication connection, indirectly via communication network 112, and/or the like). For example, database 104 may include a data storage device. In some non-limiting embodiments or aspects, database 104 may be capable of receiving information from, storing information in, communicating information to, or searching information stored in the data storage device. In some non-limiting embodiments or aspects, database 104 may be part of fee collection system 102 and/or part of the same system as fee collection system 102.

Vehicle system 106 may include one or more devices capable of receiving information from and/or communicating information to fee collection system 102 and/or database 104 (e.g., directly via a wired or wireless communication connection, indirectly via communication network 112, and/or the like). For example, vehicle system 106 may include a computing device integrated into a vehicle, such as a vehicle on-board system, a vehicle dash/entertainment system, a vehicle navigation system, and/or the like. Additionally or alternatively, each vehicle system 106 may include a device capable of receiving information from and/or communicating information to other vehicle systems 106 (e.g., directly via a wired or wireless communication connection, indirectly via communication network 112, and/or the like).

In some non-limiting embodiments or aspects, vehicle system 106 may be integrated and/or part of a vehicle. The vehicle may include a plurality of sensors configured to detect, capture, and/or transmit data (e.g., to fee collection system 102 and/or database 104). In some non-limiting embodiments or aspects, the plurality of sensors may include proximity sensors, photosensors, internal cameras, external cameras, long-range radars, short-range radars, GPS sensors, Light Detection and Ranging (LiDAR) sensors, and/or any other types of sensors.

Communication network 112 may include one or more wired and/or wireless networks. For example, communication network 112 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Additionally or alternatively, a set of systems (e.g., one or more systems) or a set of devices (e.g., one or more devices) of system 100 may perform one or more functions described as being performed by another set of systems or another set of devices of system 100.

In some non-limiting embodiments or aspects, a user of a vehicle may activate (e.g., via vehicle system 106) an account associated with fee collection system 102. In response to activating the account, fee collection system 102 may receive payment data corresponding to a payment device of the user (e.g., a device token, a token on the vehicle, a card on file, a card on file token, a cloud token, etc.) from database 104 and/or vehicle system 106. In some non-limiting embodiments or aspects, fee collection system 102 may store the payment data in a database (e.g., database 104) of fee collection system 102.

In some non-limiting embodiments, fee collection system 102 may include an artificial intelligence (Al) assisted fee electronic collection feature. In some non-limiting embodiments, fee collection system 102 may include a cloud-based fee collection system used to identify and generate fee collection payment transactions. In some non-limiting embodiments or aspects, vehicle system 106 may detect, capture, generate, and/or transmit sensor data. For example, at least one sensor of the plurality of sensors of the vehicle of vehicle system 106 may detect, capture, generate, and/or transmit the sensor data based on at least one of a location of a vehicle, a position of the vehicle, an occupancy of the vehicle, and/or any combination thereof.

In some non-limiting embodiments or aspects, vehicle system 106 may generate event data including the sensor data and a digital signature. For example, vehicle system 106 may generate the digital signature based on performing a cryptographic operation (e.g., encryption, hashing, and/or the like) on some or all of the sensor data using a cryptographic key corresponding to the vehicle. The cryptographic key may have been provisioned by a manufacturer of the vehicle and stored in a hardware security module (HSM) or the like local to the vehicle and/or a user device in communication with the vehicle. The cryptographic key may be received from vehicle system 106 and stored by a database of fee collection system 102. In some examples, the cryptographic key may be a private key of a public/private key pair, where the corresponding public key is known to others (e.g., merchants and/or payment networks) for verification purposes. In some non-limiting embodiments or aspects, the corresponding public key may be known to fee collection system 102.

In some non-limiting embodiments or aspects, the event data may include vehicle data, such as a vehicle identification code, a license plate number, a vehicle location, a vehicle position, a vehicle occupancy, a date, a time, a day of the week, and/or the like. In some non-limiting embodiments or aspects, the event data may include merchant data, such as a merchant name, a merchant address, a merchant telephone number, etc.

In some non-limiting embodiments or aspects, vehicle system 106 may conceal at least a portion of the event data. For example, vehicle system 106 may conceal at least the portion of the event data by encrypting at least the portion of the event data, removing personal identifying information (PII) from at least the portion of the event data, obfuscating at least the portion of the event data, and/or the like. Vehicle system 106 may encrypt at least the portion of the event data using a symmetric key, an asymmetric key (e.g., such as a public key of a public/private key pair), and/or the like.

In some non-limiting embodiments or aspects, vehicle system 106 may send the event data including at least the sensor data and the digital signature to fee collection system 102 in response to generating the event data and/or concealing at least the portion of the event data.

In some non-limiting embodiments or aspects, fee collection system 102 may determine a merchant system from a plurality of merchant systems based on the event data. In some non-limiting embodiments or aspects, the event data may include the location of the vehicle. In some non-limiting embodiments or aspects, fee collection system 102 may determine the merchant system from the plurality of merchant systems based on the location of the vehicle.

In some non-limiting embodiments or aspects fee collection system 102 may determine a payment event based on the event data and the merchant system.

In some non-limiting embodiments or aspects, fee collection system 102 may determine a merchant rule of a plurality of merchant rules based on the event data and the merchant system. In some non-limiting embodiments or aspects, when determining the merchant rule, fee collection system 102 may query a database (e.g., database 104) including the plurality of merchant rules.

In some non-limiting embodiments or aspects, fee collection system 102 may

generate transaction data based on the payment event. In some non-limiting embodiments or aspects, fee collection system 102 may generate a payment request message including the transaction data. In some non-limiting embodiments or aspects, fee collection system 102 may transmit the payment request message including the transaction data to the vehicle (e.g., to vehicle system 106).

In some non-limiting embodiments or aspects, fee collection system 102 may process a payment transaction based on the transaction data in response to receiving a payment confirmation message from the vehicle (e.g., from vehicle system 106).

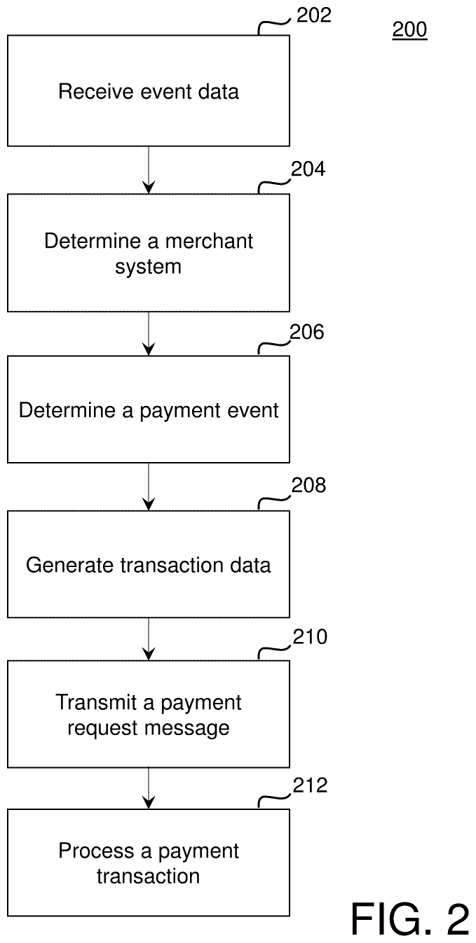

Referring now to FIG. 2, shown is a flow diagram for a method 200 for on-vehicle electronic fee collection, according to some non-limiting embodiments or aspects. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 2, at step 202, method 200 includes receiving event data. For example, fee collection system 102 may receive event data from vehicle system 106.

As shown in FIG. 2, at step 204, method 200 includes determining a merchant system. For example, fee collection system 102 may determine a merchant system from a plurality of merchant systems based on the event data.

In some non-limiting embodiments or aspects, the merchant system may be associated with a merchant (e.g., an owner/operator of a parking garage). For example, the merchant data may include a merchant name for the owner/operator of the parking garage, a merchant address for the owner/operator of the parking garage, a telephone number for the owner/operator of the parking garage, a name of the parking garage, a location of the parking garage, etc.

In some non-limiting embodiments or aspects, fee collection system 102 may determine the merchant data based on the event data. For example, fee collection system 102 may determine a merchant name for the owner/operator of the parking garage, a merchant address for the owner/operator of the parking garage, a telephone number for the owner/operator of the parking garage, a name of the parking garage, a location of the parking garage, etc. based on the vehicle location and/or the vehicle position.

As shown in FIG. 2, at step 206, method 200 includes determining a payment event. For example, fee collection system 102 may determine a payment event based on the event data and/or the merchant system.

In some non-limiting embodiments or aspects, a payment event may include an instance where a user of the vehicle is required to pay an amount (e.g., a fee) to the merchant associated with the merchant system based on the event data. For example, upon entering the parking garage, the user of the vehicle may be required to pay a fee to the owner/operator of the parking garage. A payment event may include entering a space (e.g., a parking space), exiting the space, entering a garage (e.g., a parking garage), exiting the garage, entering a lane (e.g., a toll lane, a high occupancy vehicle lane, etc.), exiting the lane, etc.

In some non-limiting embodiments or aspects, when determining the payment event, fee collection system 102 may determine a merchant rule of a plurality of merchant rules based on the merchant system and the event data. For example, the owner/operator of the parking garage may have a plurality of rules which may be used to determine an amount due based on the time of day, the day of the week, and/or the like (e.g., a user may be required to pay an hourly fee Monday through Friday, a user may be required to pay a flat fee on a Saturday, parking may be free on Sundays and/or the like). Fee collection system 102 may determine the merchant rule of the plurality of merchant rules that applies for the merchant system based on the event data. The merchant may upload and/or configure such rules through one or more graphical user interfaces (GUIs) and/or the like.

In some non-limiting embodiments or aspects, determining the merchant rule of the plurality of merchant rules may include querying a database (e.g., database 104) including the plurality of merchant rules. In some non-limiting embodiments or aspects, database 104 may include a repository of merchant rules for each merchant of the plurality of merchants. In some non-limiting embodiments or aspects, in response to determining the merchant system of the plurality of merchant systems, fee collection system 102 may query database 104 to retrieve one or more merchant rules of a plurality of merchant rules based on the event data (e.g., based on event data and/or vehicle data parameters such as date, time, type of event, type of vehicle, and/or the like).

As shown in FIG. 2, at step 208, method 200 includes generating transaction data. For example, fee collection system 102 may generate transaction data for a transaction between the user and a merchant associated with the merchant system based on the payment event and/or the merchant system. The transaction data may include the event data, the merchant data, payment event data, a transaction date, a transaction time, a transaction amount, a transaction currency, etc.

As shown in FIG. 2, at step 210, method 200 includes transmitting a payment request message. For example, fee collection system 102 may transmit the payment request message including the transaction data to vehicle system 106. In some non-limiting embodiments or aspects, vehicle system 106 may display the payment request message to the user of the vehicle via a display of a computing device.

In some non-limiting embodiments or aspects, vehicle system 106 may receive an input from the user of the vehicle including confirmation data. The confirmation data may include an approval or a denial of the payment request message. In some non-limiting embodiments or aspects, vehicle system 106 may generate and send a payment confirmation message including the confirmation data to fee collection system 102 in response to receiving the response data. In some non-limiting embodiments or aspects, vehicle system 106 may automatically generate and send the confirmation message to fee collection system 102 based on a user preference. The user preference may include a set of rules generated by the user upon activating an account with fee collection system 102. The set of rules may include a rule for each type of payment event of a plurality of types of payment events. For example, the set of rules may include an automatic payment rule for each type of payment event of the plurality of payment events.

In some non-limiting embodiments or aspects, fee collection system 102 and/or vehicle system 106 may initiate a payment transaction with the merchant system.

In some non-limiting embodiments or aspects, fee collection system 102 may generate a payment request message. For example, fee collection system 102 may generate a payment request message including the transaction data based on the payment event and the merchant system.

As shown in FIG. 2, at step 212, method 200 includes processing a payment transaction. For example, fee collection system 102 may process the payment transaction based on the transaction data in response to receiving a payment confirmation message from vehicle system 106.

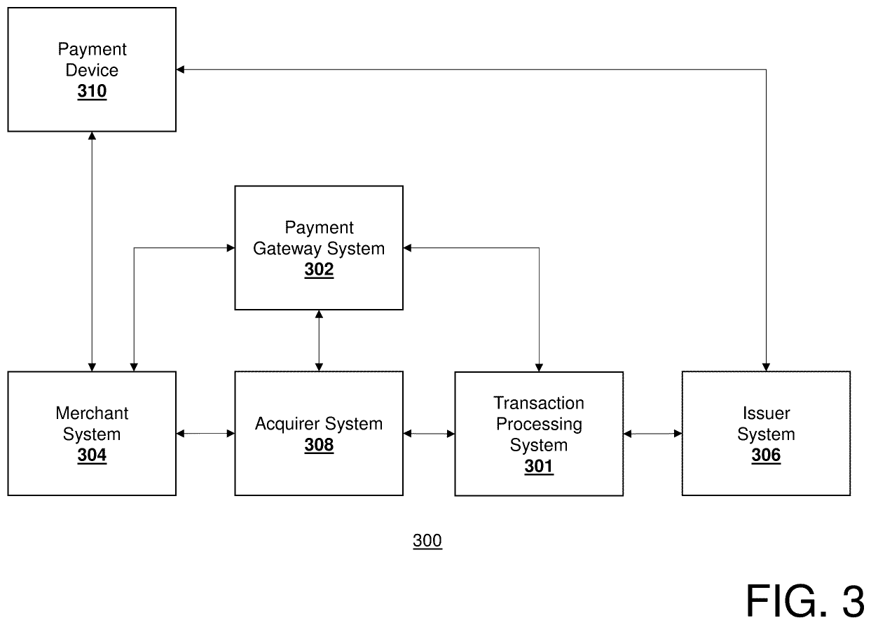

Referring now to FIG. 3, depicted is a diagram of an example payment processing network 300, according to non-limiting embodiments or aspects. In some non-limiting embodiments or aspects, payment processing network 300 may be used in conjunction with the systems, methods, and/or computer program products described herein, and/or the systems, methods, and/or computer program products described herein may be implemented in payment processing network 300. As shown in FIG. 3, payment processing network 300 may include transaction processing system 301, payment gateway system 302, merchant system 304, issuer system 306, acquirer system 308, and/or payment device 310. In some non-limiting embodiments or aspects, fee collection system 102 and/or database 104 of FIG. 1 may be implemented by (e.g., part of) transaction processing system 301. In some non-limiting embodiments or aspects, at least one of fee collection system 102 and/or database 104 of FIG. 1 may be implemented by (e.g., part of) another system, another device, another group of systems, or another group of devices, separate from or including transaction processing system 301, such as merchant system 304, issuer system 306, acquirer system 308, payment device 310, and/or the like. For example, fee collection system 102 may be implemented by (e.g., part of) at least one of payment gateway system 302, merchant system 304, issuer system 306, acquirer system 308, and/or payment device 310. Additionally or alternatively, for example, database 104 may be implemented by (e.g., part of) at least one of payment gateway system 302, merchant system 304, issuer system 306, acquirer system 308, and/or payment device 310.

Transaction processing system 301 may include one or more devices capable of receiving information from and/or communicating information to payment gateway system 302, merchant system 304, issuer system 306, acquirer system 308, payment device 310, and/or the like (e.g., directly, indirectly, via a public and/or private communication network connection, and/or the like). For example, as shown in FIG. 3, transaction processing system 301 may be in communication with one or more issuer systems (e.g., issuer system 306), one or more acquirer systems (e.g., acquirer system 308), and/or one or more payment gateway systems (e.g., payment gateway system 302). Although only a single issuer system 306, single acquirer system 308, and single payment gateway system 302 are shown, it will be appreciated that transaction processing system 301 may be in communication with a plurality of issuer systems, a plurality of acquirer systems, and/or a plurality of payment gateways. In some non-limiting embodiments or aspects, transaction processing system 301 may include a computing device, such as a server (e.g., a transaction processing server), a group of servers, and/or other like devices. In some non-limiting embodiments or aspects, transaction processing system 301 may be in communication with a data storage device, which may be local or remote to transaction processing system 301. In some non-limiting embodiments or aspects, transaction processing system 301 may be capable of receiving information from, storing information in, communicating information to, or searching information stored in the data storage device. In some non-limiting embodiments or aspects, transaction processing system 301 may be associated with a transaction service provider, as described herein. In some non-limiting embodiments or aspects, transaction processing system 301 may also operate as an issuer system such that both transaction processing system 301 and issuer system 306 are a single system and/or controlled by a single entity.

Payment gateway system 302 may include one or more devices capable of receiving information from and/or communicating information to transaction processing system 301, merchant system 304, issuer system 306, acquirer system 308, payment device 310, and/or the like (e.g., directly, indirectly, via a public and/or private communication network connection, and/or the like). For example, as shown in FIG. 3, payment gateway system 302 may be in communication with one or more merchant systems (e.g., merchant system 304), one or more acquirer systems (e.g., acquirer system 308), and/or one or more transaction processing systems (e.g., transaction processing system 301). Although only a single merchant system 304, single acquirer system 308, and single transaction processing system 301 are shown, it will be appreciated that payment gateway system 302 may be in communication with a plurality of merchant systems, a plurality of acquirer systems, and/or a plurality of transaction processing systems. In some non-limiting embodiments or aspects, payment gateway system 302 may include a computing device, such as a server, a group of servers, and/or other like devices. In some non-limiting embodiments or aspects, payment gateway system 302 may be associated with a payment gateway, as described herein.

Merchant system 304 may include one or more devices capable of receiving information from and/or communicating information to transaction processing system 301, payment gateway system 302, issuer system 306, acquirer system 308, payment device 310, and/or the like (e.g., directly, indirectly, via a public and/or private communication network connection, and/or the like). For example, as shown in FIG. 3, merchant system 304 may be in communication with one or more payment gateway systems (e.g., payment gateway system 302), one or more acquirer systems (e.g., acquirer system 308), and/or one or more consumer devices (e.g., payment device 310). Although only a single payment gateway system 302, single acquirer system 308, and single payment device 310 are shown, it will be appreciated that merchant system 304 may be in communication with a plurality of payment gateway systems, a plurality of acquirer systems, and/or a plurality of consumer devices. In some non-limiting embodiments or aspects, merchant system 304 may include a computing device, as described herein. In some non-limiting embodiments or aspects, merchant system 304 may be associated with a merchant, as described herein. In some non-limiting embodiments or aspects, merchant system 304 may include a device capable of receiving information from and/or communicating information to payment device 310 via a short-range communication connection (e.g., an NFC communication connection, an RFID communication connection, a Bluetooth® communication connection, a Zigbee® communication connection, and/or the like) with payment device 310 and/or the like. In some non-limiting embodiments or aspects, merchant system 304 may include one or more client devices. For example, merchant system 304 may include a client device that allows a merchant to communicate information to transaction processing system 301 (e.g., via at least one of acquirer system 308 and/or payment gateway system 302). In some non-limiting embodiments or aspects, merchant system 304 (e.g., a client device, a POS device thereof, and/or the like) may also operate as a payment gateway system such that both merchant system 304 and payment gateway system 302 are a single system and/or controlled by a single entity.

Issuer system 306 may include one or more devices capable of receiving information and/or communicating information to transaction processing system 301, payment gateway system 302, merchant system 304, acquirer system 308, payment device 310, and/or the like (e.g., directly, indirectly, via a public and/or private communication network connection, and/or the like). For example, as shown in FIG. 3, issuer system 306 may be in communication with one or more transaction processing systems (e.g., transaction processing system 301) and/or one or more consumer devices (e.g., payment device 310). Although only a single transaction processing system 301 and a single payment device 310 are shown, it will be appreciated that issuer system 306 may be in communication with a plurality of transaction processing systems and/or a plurality of payment devices 310. In some non-limiting embodiments or aspects, issuer system 306 may include a computing device, such as a server, a group of servers, and/or other like devices. In some non-limiting embodiments or aspects, issuer system 306 may be associated with an issuer institution, as described herein. For example, issuer system 306 may be associated with an issuer institution that issued a credit account, debit account, credit card, debit card, a payment device, and/or the like to a user associated with payment device 310.

Acquirer system 308 may include one or more devices capable of receiving information from and/or communicating information to transaction processing system 301, payment gateway system 302, merchant system 304, issuer system 306, payment device 310, and/or the like (e.g., directly, indirectly, via a public and/or private communication network connection, and/or the like). For example, as shown in FIG. 3, acquirer system 308 may be in communication with one or more transaction processing systems (e.g., transaction processing system 301), one or more payment gateway systems (e.g., payment gateway system 302), and/or one or more merchant systems (e.g., merchant system 304). Although only a single transaction processing system 301, a single payment gateway system 302, and a single merchant system 304 are shown, it will be appreciated that acquirer system 308 may be in communication with a plurality of transaction processing systems, a plurality of payment gateway systems, and/or a plurality of merchant systems. In some non-limiting embodiments or aspects, acquirer system 308 may include a computing device, such as a server, a group of servers, and/or other like devices. In some non-limiting embodiments or aspects, acquirer system 308 may be associated with an acquirer institution, as described herein.

Payment device 310 may include one or more devices capable of receiving information from and/or communicating information to transaction processing system 301, payment gateway system 302, merchant system 304, issuer system 306, acquirer system 308, and/or the like (e.g., directly, indirectly, via a public and/or private communication network connection, and/or the like). For example, as shown in FIG. 3, payment device 310 may be in communication with one or more merchant systems (e.g., merchant system 304) and/or one or more issuer systems (e.g., issuer system 306). Although only a single merchant system 304 and a single issuer system 306 are shown, it will be appreciated that payment device 310 may be in communication with a plurality of merchant systems and/or a plurality of issuer systems. In some non-limiting embodiments or aspects, payment device 310 may be associated with a user to whom a credit account, a debit account, a credit card, a debit card, a payment device, and/or the like has been issued. In some non-limiting embodiments or aspects, payment device 310 may include a computing device, as described herein. In some non-limiting embodiments or aspects, payment device 310 may include a payment device, as described herein. In some non-limiting embodiments or aspects, payment device 310 may include a device capable of receiving information from and/or communicating information to other payment devices 310 (e.g., directly, indirectly, via a public and/or private communication network connection, a short-range communication connection, and/or the like). In some non-limiting embodiments or aspects, payment device 310 may include a device capable of receiving information from and/or communicating information to merchant system 304 via a short-range communication connection with merchant system 304 and/or the like. In some non-limiting embodiments or aspects, payment device 310 may include a client device.

In some non-limiting embodiments or aspects, transaction processing system 301 may communicate with merchant system 304 directly (e.g., via a public and/or private communication network connection and/or the like). Additionally or alternatively, transaction processing system 301 may communicate with merchant system 304 through payment gateway system 302 and/or acquirer system 308. In some non-limiting embodiments or aspects, acquirer system 308 associated with merchant system 304 may operate as payment gateway system 302 to facilitate the communication of transaction messages (e.g., authorization requests) from merchant system 304 to transaction processing system 301. In some non-limiting embodiments or aspects, merchant system 304 may communicate with payment gateway system 302 directly (e.g., via a public and/or private communication network connection and/or the like). For example, merchant system 304, that includes a physical POS device, may communicate with payment gateway system 302 through a public or private network to conduct card-present transactions. As another example, merchant system 304 may include a server (e.g., a web server) which may communicate with payment gateway system 302 through a public or private network, such as the Internet, to conduct card-not-present transactions.

For the purpose of illustration, processing a transaction (e.g., a payment transaction) may include generating a transaction message (e.g., authorization request and/or the like) based on an account identifier of a consumer (e.g., accountholder associated with payment device 310 and/or the like) and/or transaction data associated with the transaction. For example, merchant system 304 (e.g., a client device of merchant system 304, a POS device of merchant system 304, and/or the like) may initiate the transaction, e.g., by generating an authorization request (e.g., in response to receiving the account identifier from a payment device and/or a portable financial device of the customer and/or the like). Merchant system 304 may communicate the authorization request to payment gateway system 302 and/or acquirer system 308. In some non-limiting embodiments or aspects, payment gateway system 302 may communicate the authorization request to acquirer system 308 and/or transaction processing system 301. Additionally or alternatively, acquirer system 308 (and/or payment gateway system 302) may communicate the authorization request to transaction processing system 301. After receiving the authorization request from merchant system 304 that identifies the account identifier of the customer (e.g., the accountholder associated with payment device 310 and/or the account identifier), transaction processing system 301 may communicate the authorization request to issuer system 306 (e.g., the issuer system that issued the payment device and/or account identifier). Issuer system 306 may determine an authorization decision (e.g., approve, deny, and/or the like) based on the authorization request, and/or issuer system 306 may generate an authorization response based on the authorization decision and/or the authorization request. Issuer system 306 may communicate the authorization response to transaction processing system 301. Transaction processing system 301 may communicate the authorization response to acquirer system 308 and/or payment gateway system 302. In some non-limiting embodiments or aspects, acquirer system 308 may communicate the authorization response to payment gateway system 302 and/or merchant system 304. Additionally or alternatively, payment gateway system 302 (and/or acquirer system 308) may communicate the authorization response to merchant system 304.

For the purpose of illustration, clearing and/or settlement of a transaction may include generating a message (e.g., clearing message and/or the like) based on an account identifier of a consumer (e.g., associated with payment device 310 and/or the like) and/or transaction data associated with the transaction. For example, merchant system 304 may generate at least one clearing message (e.g., a plurality of clearing messages, a batch of clearing messages, and/or the like). Merchant system 304 may communicate the clearing message(s) to acquirer system 308 (and/or payment gateway system 302, which may communicate the clearing message(s) to acquirer system 308). Acquirer system 308 may communicate the clearing message(s) to transaction processing system 301. Transaction processing system 301 may communicate the clearing message(s) to issuer system 306. Issuer system 306 may generate at least one settlement message based on the clearing message(s). In some non-limiting embodiments or aspects, issuer system 306 may communicate the settlement message(s) and/or funds to transaction processing system 301 (and/or a settlement bank system associated with transaction processing system 301), and transaction processing system 301 (and/or the settlement bank system) may communicate the settlement message(s) and/or funds to acquirer system 308. Additionally or alternatively, issuer system 306 may communicate the settlement message(s) and/or funds to acquirer system 308. In some non-limiting embodiments or aspects, acquirer system 308 may communicate settlement message(s) and/or funds to merchant system 304 (and/or an account associated with merchant system 304).

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of payment processing network 300 may perform one or more functions described as being performed by another set of systems or another set of devices of payment processing network 300.

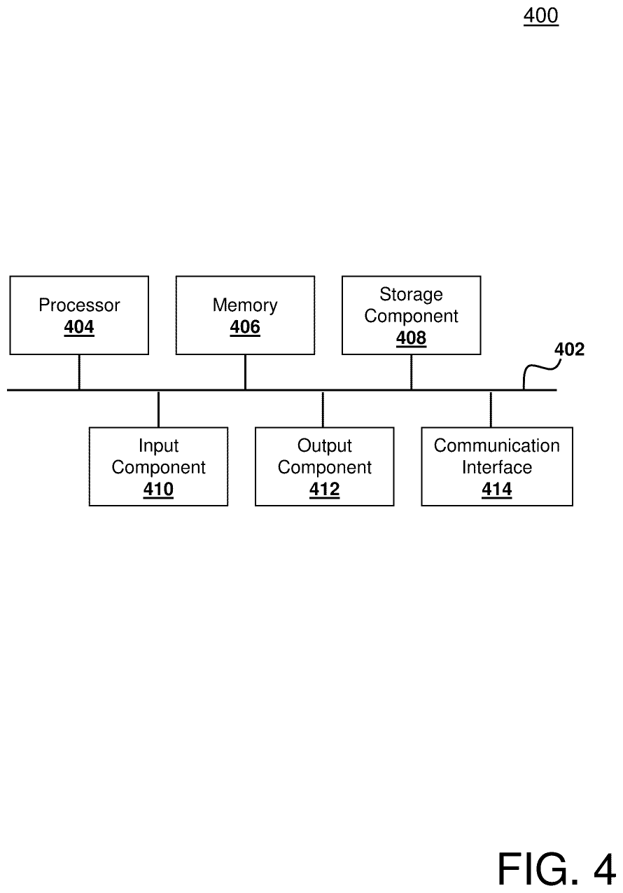

Referring now to FIG. 4, shown is a diagram of example components of a device 400, according to non-limiting embodiments or aspects. Device 400 may correspond to fee collection system 102, database 104, and/or vehicle system 106 of FIG. 1 and/or transaction processing system 301, payment gateway system 302, merchant system 304, issuer device 306, acquirer system 308, and/or payment device 310 of FIG. 3, as examples. In some non-limiting embodiments, such systems or devices may include at least one device 400 and/or at least one component of device 400. The number and arrangement of components shown are provided as an example. In some non-limiting embodiments, device 400 may include additional components, fewer components, different components, or differently arranged components than those shown. Additionally or alternatively, a set of components (e.g., one or more components) of device 400 may perform one or more functions described as being performed by another set of components of device 400.

As shown in FIG. 4, device 400 may include a bus 402, a processor 404, memory 406, a storage component 408, an input component 410, an output component 412, and a communication interface 414. Bus 402 may include a component that permits communication among the components of device 400. In some non-limiting embodiments, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 4, storage component 408 may store information and/or software related to the operation and use of device 400. For example, storage component 408 may include a hard disk (e.g., a magnetic disk, an optical disk, a magneto-optic disk, a solid-state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

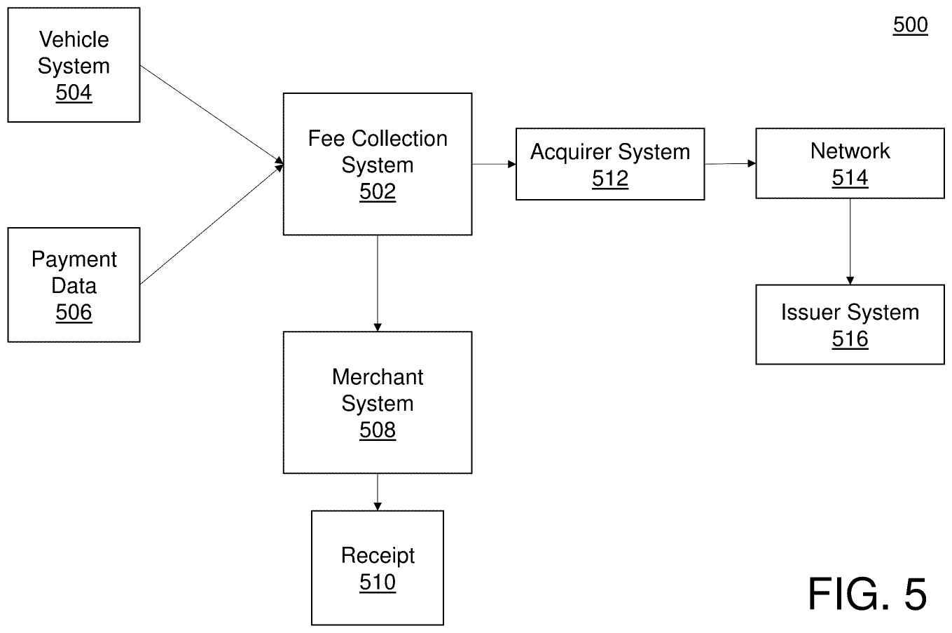

Referring now to FIG. 5, shown is a diagram of a system 500 for on-vehicle electronic fee collection according to some non-limiting embodiments or aspects. As shown in FIG. 5, system 500 may include fee collection system 502, vehicle system 504, payment data 506, merchant system 508, receipt 510, acquirer system 512, network 514, and/or issuer system 516. Fee collection system 502 may be the same as, similar to, and/or part of fee collection system 102 shown and described in connection with FIG. 1. Vehicle system 504 may be the same as, similar to, and/or part of vehicle system 106 shown and described in connection with FIG. 1. Merchant system 508 may be the same as, similar to, and/or part of merchant system 304 shown and described in connection with FIG. 3. Acquirer system 512 may be the same as, similar to, and/or part of acquirer system 308 shown and described in connection with FIG. 3. Network 514 may be the same as, similar to, and/or part of communication network 112 shown and described in connection with FIG. 1. Issuer system 516 may be the same as, similar to, and/or part of issuer system 306 shown and described in connection with FIG. 3.

In some non-limiting embodiments or aspects, a user may create an account associated with fee collection system 502. The user may link payment data 506 (e.g., device token, card on file, card on file token, cloud token) to the account.

In some non-limiting embodiments or aspects, vehicle system 504 may generate event data including the sensor data and a digital signature. In some non-limiting embodiments or aspects, the event data may include vehicle data, such as a vehicle identification code, a license plate number, a vehicle location, a vehicle position, a vehicle occupancy, a date, a time, a day of the week, and/or the like. In some non-limiting embodiments or aspects, the event data may include merchant data, such as a merchant name, a merchant address, a merchant telephone number, etc.

In some non-limiting embodiments or aspects, vehicle system 504 may conceal the event data. For example, vehicle system 504 may conceal the event data by encrypting the event data, removing PII from the event data, obfuscating the event data, and/or the like. Vehicle system 504 may encrypt the event data using a symmetric key, an asymmetric key (e.g., such as a public key of a public/private key pair), and/or the like. Vehicle system 504 may send event data including at least the sensor data and the digital signature to fee collection system 502 in response to generating the event data.

In some non-limiting embodiments or aspects, vehicle system 504 may include a machine learning model. The machine learning model may include an Al model. The machine learning model may be trained to generate and/or output the event data. For example, the machine learning model may be trained to generate and/or output the event data based on input data received from the plurality of sensors of vehicle system 504. In some non-limiting embodiments or aspects, the input data may include lane position, lane stay period, lane change, entry, exit, vehicle occupancy information, parking lot position, entry time, exit time, and/or vehicle information. The machine learning model may also be hosted remote from the vehicle system 504, such as on a server computer that is in communication with the vehicle system 504.

In some non-limiting embodiments or aspects, fee collection system 502 may receive payment data 506.

In some non-limiting embodiments or aspects, fee collection system 502 may determine merchant system 508 from a plurality of merchant systems based on the event data. In some non-limiting embodiments or aspects, fee collection system 502 may determine a merchant rule of a plurality of merchant rules associated with merchant system 508.

In some non-limiting embodiments or aspects, fee collection system 502 may determine a payment event based on the event data and the merchant rule for merchant system 508. In some non-limiting embodiments or aspects, the payment event may include a requirement of the payment of a fee by the user.

In some non-limiting embodiments or aspects, fee collection system 502 may initiate a payment transaction with merchant system 508 for a transaction between merchant system 508 and the user based on determining the payment event. For example, fee collection system 502 may automatically initiate a payment with merchant system 508 in response to determining that a fee is required based on the merchant rule for merchant system 508.

In some non-limiting embodiments or aspects, fee collection system 502 may generate transaction data based on the payment event. The transaction data may include an amount and/or a currency for the transaction between merchant system 508 and the user. In some non-limiting embodiments or aspects, fee collection system 502 may generate a payment request message including the transaction data. In some non-limiting embodiments or aspects, fee collection system 502 may transmit the payment request message comprising the transaction data to vehicle system 504.

In some non-limiting embodiments or aspects, vehicle system 504 may sign the event data using a second cryptographic key. In some examples, the second cryptographic key may be a second private key of a second public/private key pair, where the corresponding public key is known to others (e.g., merchants and/or payment networks) for verification purposes. Vehicle system 504 may use payment data 506 to complete the payment transaction.

In some non-limiting embodiments or aspects, issuer system 516 may authorize the transaction. Merchant system 508 may generate receipt 510 and send the receipt to vehicle system 504. In some non-limiting embodiments or aspects, vehicle system 504 may store the signed event data and/or receipt 510 in a database.

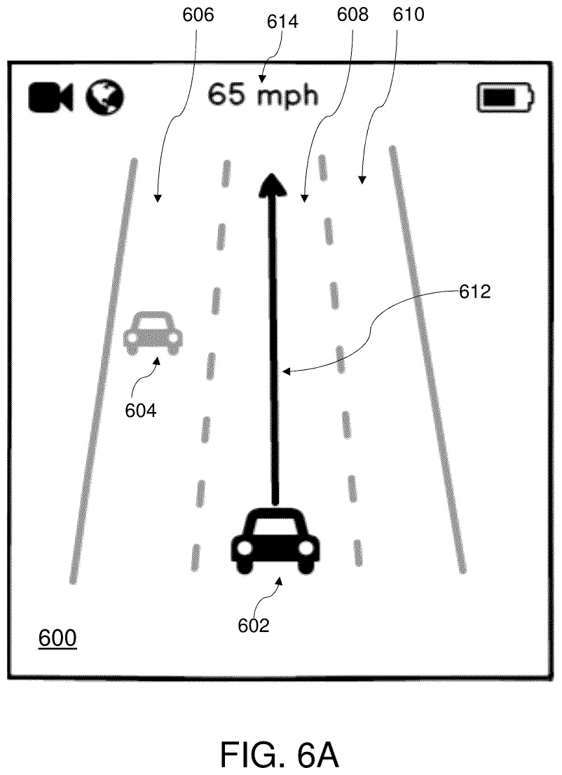

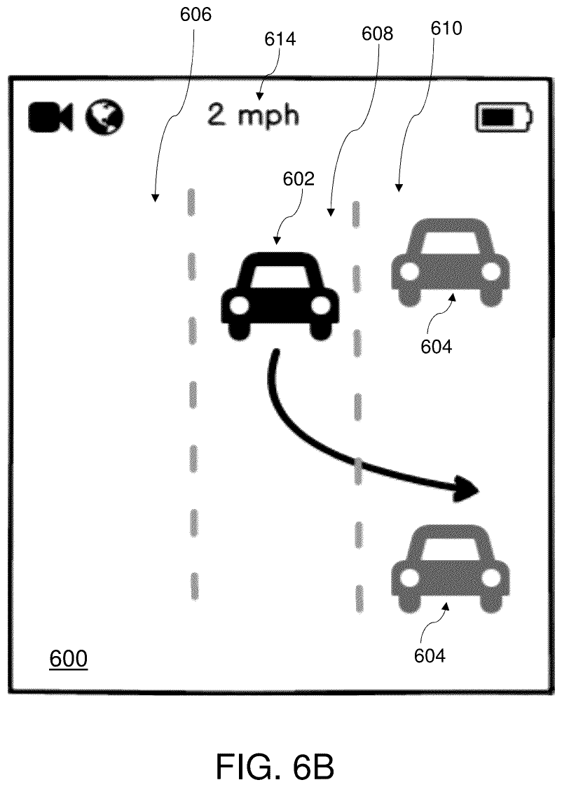

Referring now to FIGS. 6A and 6B, shown are diagrams of an implementation 600 of a method (e.g., method 200) for on-vehicle electronic fee collection according to some non-limiting embodiments or aspects. FIGS. 6A and 6B show a display screen (e.g., GUI) that may be displayed by vehicle system 106 to show vehicle 602 in a surrounding environment and to illustrate exemplary payment events that the vehicle may engage in. Vehicle system 106 may include a plurality of sensors, an on-vehicle computing unit, and/or artificial intelligence enabled software. Vehicle system 106 may detect a position of vehicle 602. For example, vehicle system 106 may detect a lane position of vehicle 602 in a lane (e.g., lane 608) of a plurality of lanes (e.g., lanes 606, 608, 610), as shown in FIG. 6A. Vehicle 602 may detect a direction 612 that vehicle 602 is traveling in. Vehicle system 106 may determine a speed 614 at which vehicle 602 is traveling. Vehicle system 106 may determine a position and/or distance from one or more other vehicles 604. In some non-limiting embodiments or aspects, vehicle system 106 may detect a parking position of vehicle 602, as shown in FIG. 6B. For example, vehicle system 106 may detect a parking position of vehicle 602 based on one or more other vehicles 604 for parking assistance.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system, comprising:
at least one processor configured to:
receive event data from a vehicle operated by a user, the event data comprising a digital signature based on sensor data generated by at least one sensor of the vehicle;
determine a merchant system from a plurality of merchant systems based on the event data;
determine a payment event based on the event data and the merchant system;
generate transaction data based on the payment event;
transmit a payment request message comprising the transaction data to the vehicle; and
process a payment transaction based on the transaction data in response to receiving a payment confirmation message from the vehicle.

2. The system of claim 1, wherein the at least one processor is further configured to:
receive payment data corresponding to a payment device of the user; and
store the payment data in a database.

3. The system of claim 1, wherein the event data comprises a location of the vehicle, and wherein determining the merchant system from the plurality of merchant systems is based on the location of the vehicle.

4. The system of claim 1, wherein the at least one processor is further configured to:
determine a merchant rule of a plurality of merchant rules based on the event data and the merchant system.

5. The system of claim 4, wherein, when determining the merchant rule of the plurality of merchant rules, the at least one processor is configured to:
query a database including the plurality of merchant rules.

6. The system of claim 1, wherein the digital signature is based on a cryptographic key corresponding to the vehicle.

7. The system of claim 1, wherein the at least one processor is further configured to:
generate a payment request message including the transaction data.

8. A computer-implemented method, comprising:
receiving, with at least one processor of a server computer, event data from a vehicle operated by a user, the event data comprising a digital signature based on sensor data generated by at least one sensor of the vehicle;
determining, with at least one processor of the server computer, a merchant system from a plurality of merchant systems based on the event data;
determining, with at least one processor of the server computer, a payment event based on the event data and the merchant system;
generating, with at least one processor of the server computer, transaction data based on the payment event;
transmitting, with at least one processor of the server computer, a payment request message comprising the transaction data to the vehicle; and
processing, with at least one processor of the server computer, a payment transaction based on the transaction data in response to receiving a payment confirmation message from the vehicle.

9. The computer-implemented method of claim 8, further comprising:
receiving payment data corresponding to a payment device of the user; and
storing the payment data in a database.

10. The computer-implemented method of claim 8, wherein the event data comprises a location of the vehicle, and wherein determining the merchant system from the plurality of merchant systems is based on the location of the vehicle.

11. The computer-implemented method of claim 8, further comprising:
determining a merchant rule of a plurality of merchant rules based on the event data and the merchant system.

12. The computer-implemented method of claim 11, wherein determining the merchant rule of the plurality of merchant rules comprises:
querying a database including the plurality of merchant rules.

13. The computer-implemented method of claim 8, wherein the digital signature is based on a cryptographic key corresponding to the vehicle.

14. The computer-implemented method of claim 8, further comprising:
generating a payment request message including the transaction data.

15. A computer program product comprising at least one non-transitory computer-readable medium including program instructions that, when executed by at least one processor, cause the at least one processor to:
receive event data from a vehicle operated by a user, the event data comprising a digital signature based on sensor data generated by at least one sensor of the vehicle;
determine a merchant system from a plurality of merchant systems based on the event data;
determine a payment event based on the event data and the merchant system;
generate transaction data based on the payment event;
transmit a payment request message comprising the transaction data to the vehicle; and
process a payment transaction based on the transaction data in response to receiving a payment confirmation message from the vehicle.

16. The computer program product of claim 15, wherein the instructions further cause the at least one processor to:
receive payment data corresponding to a payment device of the user; and
store the payment data in a database.

17. The computer program product of claim 15, wherein the event data comprises a location of the vehicle and wherein determining the merchant system from the plurality of merchant systems is based on the location of the vehicle.

18. The computer program product of claim 15, wherein the instructions further cause the at least one processor to:
determine a merchant rule of a plurality of merchant rules based on the event data and the merchant system.

19. The computer program product of claim 18, wherein, when determining the merchant rule of the plurality of merchant rules, the instructions cause the at least one processor to:
query a database including the plurality of merchant rules.

20. The computer program product of claim 15, wherein the digital signature is based on a cryptographic key corresponding to the vehicle.
